(19) United States
(12) Patent Application Publication
(10) Pub. No.: US 2022/0155475 A1
(43) Pub. Date: May 19, 2022

(54) IRREGULAR OPTIMIZED ACQUISITION METHOD, DEVICE, APPARATUS AND MEDIUM FOR SEISMIC DATA

(71) Applicant: INSTITUTE OF GEOLOGY AND GEOPHYSICS CHINESE ACADEMY OF SCIENCES (IGGCAS), Beijing (CN)

(72) Inventors: Xiaocai SHAN, Beijing (CN); Yao LV, Beijing (CN); Yongjian ZHOU, Beijing (CN); Zongwei LI, Beijing (CN); Changchun YANG, Beijing (CN)

(21) Appl. No.: 17/128,463

(22) Filed: Dec. 21, 2020

(30) Foreign Application Priority Data
Nov. 13, 2020 (CN) 202011267100.2

(51) Int. Cl. G01V 1/28; G06F 17/16; G06F 17/15

(52) U.S. Cl. CPC G01V 1/28; G06F 17/15; G06F 17/16

(57) ABSTRACT

An irregular optimization acquisition method, device, apparatus and medium for seismic data are provided. The method comprises the steps of: for the sampling matrix ϕ_{N} to be optimized, updating the sampling matrix to ϕ_{N-n} according to a sampling reduction solution based on a greedy sequential scheme in alternate directions, and updating the sampling matrix to ϕ_{N} according to a sampling increment solution based on the greedy sequential scheme in alternate directions; and determining whether to end the cycle according to the compressed sensing theory, a preset number m and a termination condition for overall optimization, and outputting a final optimization sampling matrix. The method, the device, the apparatus and the medium provided by the disclosure are used for solving the technical problems that the existing irregular seismic acquisition solution is easy to fall into local optimum solution, large in calculation amount and not suitable for complex terrain areas.

### CROSS-REFERENCE TO RELATED APPLICATIONS

The application claims priority to Chinese patent application No. 202011267100.2, filed on Nov. 13, 2020, the entire contents of which are incorporated herein by reference.

### TECHNICAL FIELD

The disclosure relates to the technical field of sampling, in particular to an irregular optimized acquisition method, device, apparatus and medium for seismic data.

### BACKGROUND

Regular sampling construction is adopted in the traditional seismic exploration data acquisition, and shot points and detection points are uniformly distributed on a regular grid. According to the Shannon-Nyquist sampling theorem in classical signal processing, the sampling frequency must be higher than twice the bandwidth of the original signal in order to keep the acquired data undistorted.

In order to describe the fine features of a target body, it is often necessary to acquire a more accurate signal. Therefore, it is needed to encrypt the number of sampling points in space. Such an acquisition mode greatly increases the amount of data acquired, resulting in a sharp increase in acquisition costs.

In addition, during a construction in complex areas, the situation that a detector is difficult or even impossible to arrange in a steep wall, a river, a gully, a village, an industrial area and the like is often encountered, so that certain difficulties are brought to the regular acquisition solution, and even the situation that the sampling points cannot be evenly arranged for the acquisition occurs. If a large amount of original data is lost for these reasons, the exploration quality and imaging effect of the whole work area will be seriously affected, which will bring difficulties to data interpretation.

### SUMMARY

In view of the above problems, the present disclosure has been made to provide an irregular optimized acquisition method, device, apparatus and medium for seismic data that overcomes or at least partially solves the above problems.

An irregular optimization acquisition method for seismic data comprises the steps of: executing a following fine-tuning cycle: sequentially reducing n sampling points for a sampling matrix ϕ_{N} to be optimized and updating the sampling matrix to ϕ_{N-n} according to a sampling reduction solution based on a greedy sequential scheme in alternating directions, wherein n is a preset fine-tuning amplitude value, and N is greater than n;

sequentially adding n sampling points for ϕ_{N-n} and updating the sampling matrix to ϕ_{N}′ according to a sampling increment solution based on the greedy sequential scheme in alternate directions; judging whether the value μ of the current sampling matrix ϕ_{N}′ is less than the value μ of the sampling matrix ϕ_{N} according to the compressed sensing theory, wherein the value μ is a maximum cross-correlation value among column vectors of a sensing matrix in the compressed sensing theory; if so, changing ϕ_{N} to ϕ_{N}′, ending the fine-tuning cycle for ϕ_{N} and repeatedly executing the fine-tuning cycle for ϕ_{N}′; if not, increasing rejection times of the current fine-tuning amplitude by one without changing the current sampling matrix, and judging whether the rejection times reaches a preset number m; if not, returning to repeatedly execute the fine-tuning cycle on the basis of the current sampling matrix until the rejection times reaches the preset number m; if so, judging whether n meets a termination condition for overall optimization, and here, if not, reducing the fine-tuning amplitude n, and returning to repeatedly execute the fine-tuning cycle on the basis of the current sampling matrix until n meets the termination condition for overall optimization, and if so, ending the cycle and outputting a final optimized sampling matrix.

Further, in the irregular optimization acquisition method for seismic data, the termination condition for overall optimization is that the fine-tuning amplitude n reaches a minimum value nₛₑₜ of a preset fine-tuning amplitude.

Further, in the irregular optimization acquisition method for seismic data, the sampling reduction solution based on a greedy sequential scheme in alternating directions includes: executing a traversal reduction cycle: randomly selecting one sampled point as a candidate point for the sampling matrix ϕ_{N}; traversing all sampled points along an x direction of the candidate point, respectively calculating the value μ of ϕ_{N} after each sampled point is reduced, and selecting the sampled point causing the value μ to be minimum to substitute the candidate point; traversing all sampled points along a y direction of the substituted candidate point, respectively calculating the value μ of ϕ_{N} after each sampled point is reduced, and selecting the sampled point causing the value μ to be minimum to substitute the candidate point; judging whether the substituted candidate point causes the value μ to be minimum in both the x direction and the y direction; if not, returning to repeat the traversal reduction cycle until the candidate point causes the value μ to be minimum in the x direction and the y direction; and if so, deleting the candidate point from the sampling matrix ϕ_{N}, and updating the sampling matrix to ϕ_{N-1}; judging whether the number of the deleted sampling points reaches the fine-tuning amplitude n; if not, repeating the traversal reduction cycle for ϕ_{N-1} until the number of deleted sampling points reaches the fine-tuning amplitude n; and if so, outputting the updated optimized sampling matrix ϕ_{N-n} at the current fine-tuning amplitude.

Further, in the irregular optimization acquisition method for seismic data, the sampling increment solution based on the greedy sequential scheme in alternate directions includes: executing a traversal increase cycle: randomly selecting one unsampled point as a candidate point for the sampling matrix ϕ_{N-n}; traversing all the unsampled points along the x direction of the candidate point, respectively calculating the value μ of ϕ_{N-n} after each unsampled point is added, and selecting the unsampled point causing the value μ to be minimum to substitute the current candidate point; traversing all the unsampled points along the y direction of the substituted candidate point, respectively calculating the value μ of ϕ_{N-n} after each unsampled point is added, and selecting the unsampled point causing the value μ to be minimum to substitute the candidate point; judging whether the substituted candidate point causes the value μ to be minimum in both the x direction and the y direction; if not, returning to repeat the traversal increase cycle until the candidate point causes the value μ to be minimum in the x direction and the y direction; and if so, adding the candidate point into the sampling matrix ϕ_{N-n}, and updating the sampling matrix to ϕ_{N-n+1}; judging whether the number of added sampling points reaches the fine-tuning amplitude n; if not, repeating the traversal increase cycle for ϕ_{N-n+1} until the number of added sampling points reaches the fine-tuning amplitude n; and if so, outputting the updated optimized sampling matrix ϕ_{N}′ at the current fine-tuning amplitude.

Further, the irregular optimization acquisition method for seismic data further comprises a generation solution of the sampling matrix to be optimized: letting an initial sampling matrix of the sampling matrix ϕ_{N} to be optimized be ϕₖ, wherein k is greater than 0 and less than N, an unsampled point is randomly selected as a candidate point, and a following first cycle is executed: traversing all the unsampled points along the x direction of the current candidate point according to the compressed sensing theory, and respectively calculating the value ₁1 of ϕₖ after each unsampled point is added; and selecting the unsampled point causing the value μ to be minimum to substitute the candidate point; ending the first cycle, and executing a following second cycle by starting from the substituted candidate point: traversing all the unsampled points along the y direction of the candidate point, and respectively calculating the value μ of ϕₖ after each unsampled point is added; and selecting the unsampled point causing the value μ to be minimum to substitute the candidate point; judging whether the substituted candidate point meets that the value μ is minimum in both the x direction and the y direction; if not, repeating the first cycle and the second cycle until the substituted candidate point causes the value μ to be minimum in the x direction and the y direction; if so, adding the substituted candidate point into the initial sampling matrix ϕₖ, updating the initial sampling matrix to ϕₖ₊₁, and judging whether a termination condition for a generation stage is met, and here, if not, repeating the cycle above, adding a new sampling point and updating the initial acquisition matrix until the termination condition of the generation stage is met, and if so, outputting the updated initial acquisition matrix as the acquisition matrix ϕ_{N} to be optimized.

Further, in the irregular optimization acquisition method for seismic data, the termination condition of the generation stage is that the number k+1 of sampling points of the updated initial sampling matrix ϕₖ₊₁ reaches a preset sampling number N; or the value μ of the updated initial sampling matrix ϕₖ₊₁ is less than a preset value μₛₑₜ.

Further, the irregular optimization acquisition device for seismic data comprises a fine-tuning cycle module configured for: executing a following fine-tuning cycle: sequentially reducing n sampling points for a sampling matrix ϕ_{N} to be optimized and updating the sampling matrix to ϕ_{N-n} according to a sampling reduction solution based on a greedy sequential scheme in alternate directions, where n is a preset fine-tuning amplitude value, and N is greater than n; sequentially adding n sampling points for ϕ_{N-n}. and updating the sampling matrix to ϕ_{N}′ according to a sampling increment solution based on the greedy sequential scheme in alternate directions; judging whether the value μ of the current sampling matrix ϕ_{N}′ is less than the value μ of the sampling matrix ϕ_{N} according to the compressed sensing theory, wherein the value μ is a maximum cross-correlation value among column vectors of a sensing matrix in the compressed sensing theory; if so, changing ϕ_{N} to ϕ_{N}′, ending the fine-tuning cycle for ϕ_{N}, and repeatedly executing the fine-tuning cycle for ϕ_{N}′; if not, increasing rejection times of the current fine-tuning amplitude by one without changing the current sampling matrix, and judging whether the rejection times reaches a preset number m; if not, returning to repeatedly execute the fine-tuning cycle on the basis of the current sampling matrix until the rejection times reaches the preset number m; if so, judging whether n meets a termination condition for overall optimization, and here, if not, reducing the fine-tuning amplitude n, and returning to repeatedly execute the fine-tuning cycle on the basis of the current sampling matrix until n meets the termination condition for overall optimization, and if so, ending the cycle and outputting a final optimized sampling matrix.

Further, the irregular optimization acquisition device for seismic data further comprises a generation module of the sampling matrix to be optimized configured for: letting an initial sampling matrix of the sampling matrix ϕ_{N} to be optimized be ϕₖ, wherein k is greater than 0 and less than N, an unsampled point is randomly selected as a candidate point, and a following first cycle is executed: traversing all the unsampled points along the x direction of the current candidate point according to the compressed sensing theory, and respectively calculating the value ₁1 of ϕₖ after each unsampled point is added; and selecting the unsampled point causing the value μ to be minimum to substitute the candidate point; ending the first cycle, and executing a following second cycle by starting from the substituted candidate point: traversing all the unsampled points along the y direction of the candidate point, and respectively calculating the value μ of ϕₖ after each unsampled point is added; and selecting the unsampled point causing the value pt to be minimum to substitute the candidate point; judging whether the substituted candidate point meets that the value μ is minimum in both the x direction and the y direction; if not, repeating the first cycle and the second cycle until the substituted candidate point causes the value μ to be minimum in the x direction and the y direction; if so, adding the substituted candidate point into the initial sampling matrix ϕₖ, updating the initial sampling matrix to ϕₖ₊₁, and judging whether a termination condition for a generation stage is met, and here, if not, repeating the cycle above, adding a new sampling point and updating the initial acquisition matrix until the termination condition of the generation stage is met, and if so, outputting the updated initial acquisition matrix as the acquisition matrix ϕ_{N} to be optimized.

Further, an irregular optimization acquisition apparatus for seismic data comprises a processor and a computer program stored on the memory and executable on the processor, wherein the processor, when executing the program, implements the steps mentioned above.

Further, an irregular optimization acquisition medium for seismic data has stored thereon a computer program which, when executed by a processor, implements the steps mentioned above.

The technical solutions provided by the embodiments of the disclosure have at least the following technical effects or advantages.

According to the irregular optimized acquisition method, device, apparatus, and medium provided by the embodiments of the disclosure, the sampling matrix is updated from the sampling matrix ϕ_{N} to be optimized to ϕ_{N} by combining a sampling reduction solution based on a greedy sequential scheme in alternate directions and a sampling increment solution based on the greedy sequential scheme in alternate directions, and whether the value μ of the updated sampling matrix ϕ_{N} is less than that of the sampling matrix ϕ_{N} is judged according to the compressed sensing theory to judge whether the fine-tuning is accepted; and the trend of fine-tuning is to make the sampling matrix meet the requirements of better integrity and ensure the reliability of sampling results. Furthermore, whether the rejection times reaches a preset number m is taken as a cycle judgment condition, and the fine-tuning amplitude n is gradually reduced to execute the cycle to determine a final optimized sampling matrix. Therefore, the final optimized sampling matrix subjected to fine-tuning optimization does not need to perform mechanical average division and arrange average densely sampling points to a region, and suitable sampling points can be determined by the solution of the disclosure even in a complex terrain region without performing candidate point optimization on the region which cannot be sampled. In addition, the solution has small calculation amount and high overall performance, and can guarantee the reliability of a sampling result by updating the sampling points based on overall fine-tuning optimization. The sampling number is less than that required by conventional regular sampling. It is not easy to fall into the local optimal solution of other irregular sampling solutions, and the sampling cost can be greatly reduced while the sampling effect is guaranteed.

The above description is merely a summary of the technical solution of the present disclosure. In order that the technical means of the present disclosure may be more clearly understood, it may be carried out in accordance with the contents of the description. In addition, specific embodiments of the present disclosure are hereinafter set forth for purpose that the above and other objects, features and advantages of the present disclosure may be more clearly understood.

### BRIEF DESCRIPTION OF DRAWINGS

Various other advantages and benefits will become apparent to those of ordinary skill in the art upon reading the following detailed description of the preferred embodiments. The drawings are only for the purpose of illustrating preferred embodiments and are not to be construed as limiting the disclosure. Also, throughout the drawings, like reference numerals designate like parts. In the drawings:

FIG. 1 is a flow chart of an irregular optimized acquisition method for seismic data in an embodiment of the present disclosure;

FIG. 2 is a flowchart of a method for obtaining a sampling matrix ϕ_{N} to be optimized in an embodiment of the present disclosure;

FIG. 3 is a schematic diagram I of obtaining a sampling matrix ϕ_{N} to be optimized in an embodiment of the present disclosure;

FIG. 4 is a schematic diagram II of obtaining a sampling matrix ϕ_{N} to be optimized in an embodiment of the present disclosure;

FIG. 5 is a schematic diagram III of obtaining a sampling matrix ϕ_{N} to be optimized in an embodiment of the present disclosure;

FIG. 6 is a schematic diagram IV of obtaining a sampling matrix ϕ_{N} to be optimized in an embodiment of the present disclosure;

FIG. 7 is a schematic diagram V of obtaining a sampling matrix ϕ_{N} to be optimized in an embodiment of the present disclosure;

FIG. 8 is a schematic diagram VI of obtaining a sampling matrix ϕ_{N} to be optimized in an embodiment of the present disclosure;

FIG. 9 is a schematic diagram VII of obtaining a sampling matrix ϕ_{N} to be optimized in an embodiment of the present disclosure;

FIG. 10 is a schematic diagram VIII of obtaining a sampling matrix ϕ_{N} to be optimized in an embodiment of the present disclosure;

FIG. 11 is a flow diagram of a sampling reduction solution based on a greedy sequential scheme in alternate directions in an embodiment of the present disclosure;

FIG. 12 is a flow diagram of a sampling increment solution based on the greedy sequential scheme in alternate directions in an embodiment of the present disclosure;

FIG. 13 is a schematic diagram I of a sample reduction solution in an embodiment of the present disclosure;

FIG. 14 is a schematic diagram II of the sample reduction solution in an embodiment of the present disclosure;

FIG. 15 is a schematic diagram III of the sampling reduction solution in an embodiment of the present disclosure;

FIG. 16 is a schematic diagram IV of a sampling reduction solution in an embodiment of the present disclosure;

FIG. 17 is a schematic diagram V of a sampling reduction solution in an embodiment of the present disclosure;

FIG. 18 is a schematic diagram of a sampling increment solution in an embodiment of the present disclosure;

FIG. 19 is a schematic view of an acquisition device for seismic data in an embodiment of the present disclosure;

FIG. 20 is a schematic diagram of an electronic apparatus in an embodiment of the present disclosure; and

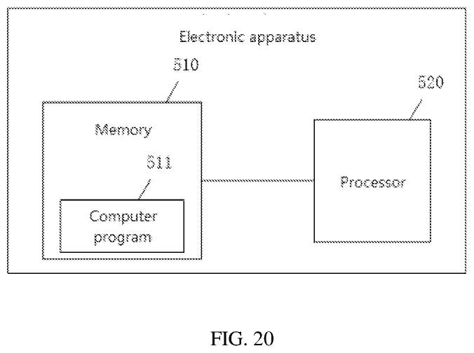

FIG. 21 is a schematic diagram of a storage medium in an embodiment of the present disclosure.

### DETAILED DESCRIPTION OF THE EMBODIMENTS

Exemplary embodiments of the present disclosure will be described in more detail below with reference to the accompanying drawings. While there are shown in the drawings exemplary embodiments of the present disclosure, it should be understood that the present disclosure may be embodied in various forms and should not be limited to the embodiments set forth herein. Rather, these embodiments are provided to enable a more thorough understanding of the present disclosure, and will fully convey the scope of the disclosure to those skilled in the art.

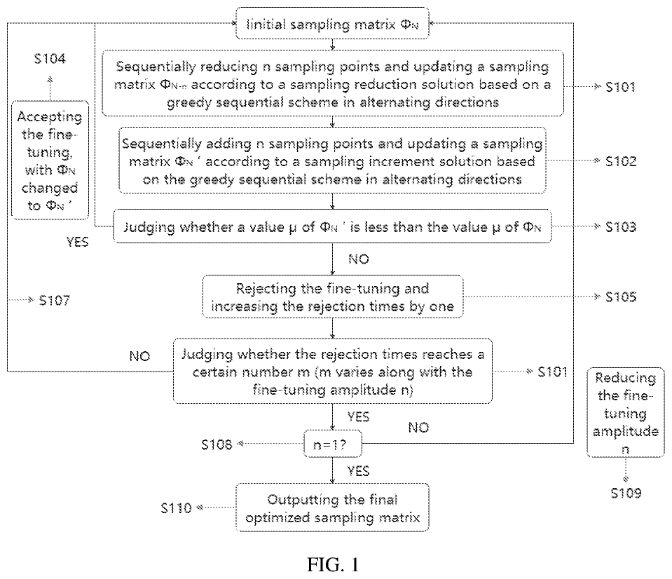

The disclosure provides an irregular optimization acquisition method for seismic data, as shown in FIG.1, and comprises the steps of:

executing a following fine-tuning cycle:

Step S101, sequentially reducing n sampling points for a sampling matrix ϕ_{N} to be optimized and updating the sampling matrix to ϕ_{N-n} according to a sampling reduction solution based on a greedy sequential scheme in alternating directions, n is a preset fine-tuning amplitude value, and N is greater than n;

Step S102, sequentially adding n sampling points for ϕ_{N-n} and updating the sampling matrix to ϕ_{N} according to a sampling increment solution based on the greedy sequential scheme in alternate directions;

Step S103, judging whether the value μ of the current sampling matrix ϕ_{N} is less than the value μ of the sampling matrix ϕ_{N} according to the compressed sensing theory, and the value μ is a maximum cross-correlation value among column vectors of a sensing matrix in the compressed sensing theory;

Step S104, if so, changing ϕ_{N} to ϕ_{N}, ending the fine-tuning cycle for ϕ_{N}, and repeatedly executing the fine-tuning cycle for ϕ_{N};

Step S105, if not, increasing rejection times of the current fine-tuning amplitude by one without changing the current sampling matrix;

Step S106, judging whether the rejection times reaches a preset number m, where m varies inversely proportional to the fine-tuning amplitude n;

Step S107, if not, returning to repeatedly execute the fine-tuning cycle on the basis of the current sampling matrix until the rejection times reaches the preset number m;

Step S108, if so, judging whether n meets a termination condition for overall optimization (assuming that the termination condition for overall optimization is n=1 in FIG. 1);

Step S109, if not, reducing the fine-tuning amplitude n, returning to repeatedly execute the fine-tuning cycle on the basis of the current sampling matrix until n meets the termination condition for overall optimization; and

Step S110, if so, ending the cycle and outputting a final optimized sampling matrix.

In particular, the irregular optimized acquisition method for seismic data can be applied to a dedicated acquisition device or to equipment such as a computer, without limitation.

It should be noted that the present application does not relate to the specific seismic data content of a sample, which may be any existing seismic sample data.

Detailed implementation steps of the irregular optimized acquisition method for seismic data provided by the present application are described in detail below with reference to FIG. 1.

First, a sampling matrix ϕ_{N} to be optimized is determined, which may be a sampling matrix preset empirically or may be a sampling matrix obtained in the manner of cycling according to a greedy sequential scheme in alternating directions, without limitation.

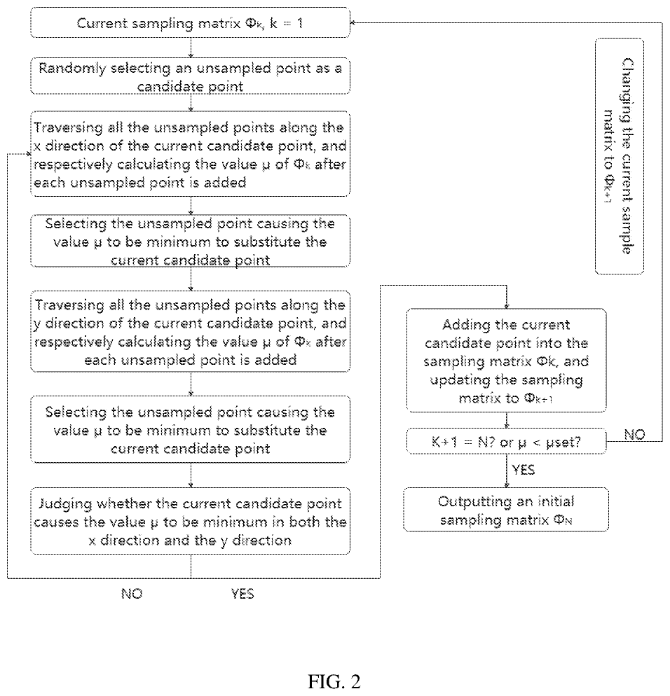

Specifically, a method for obtaining a sampling matrix to be optimized in the manner of cycling according to the greedy sequential scheme in alternating directions is shown in FIG. 2. The initial sampling matrix ϕₖ of the sampling matrix ϕ_{N} to be optimized is set first, and k can be equal to 1, or other values such as 2 or 3, without limitation. Then, one unsampled point is randomly selected as a candidate point, and the following first cycle is executed, including: traversing all the unsampled points along the x direction of the current candidate point according to the compressed sensing theory, and respectively calculating the value μ of ϕₖ after each unsampled point is added; and selecting the unsampled point causing the value μ to be minimum to substitute the candidate point. Then, the first cycle is ended, and a following second cycle is executed by starting from the candidate point after substitution, including: traversing all the unsampled points along the y direction of the candidate point, and respectively calculating the value μ of ϕₖ after each unsampled point is added; and selecting the unsampled point causing the value pt to be minimum to substitute the candidate point;

judging whether the substituted candidate point meets that the value μ is minimum in both the x direction and the y direction; if not, repeating the first cycle and the second cycle until the substituted candidate point causes the value pt to be minimum in the x direction and the y direction; if so, adding the substituted candidate point into the initial sampling matrix ϕₖ, updating the initial sampling matrix to ϕₖ₊₁, and judging whether a termination condition for a generation stage is met, and here, if not, adding a new sampling point, updating the initial acquisition matrix so that k=k+1, and repeating the cycle above until the termination condition of the generation stage is met, and if so, outputting the updated initial acquisition matrix ϕₖ₊₁ as the acquisition matrix ϕ_{N} to be optimized.

The termination condition of the generation stage is as follows: the number k+1 of sampling points of the updated initial sampling matrix ϕₖ₊₁ reaches a preset sampling number N; or the value ₁1 of the updated initial sampling matrix ϕₖ₊₁ is less than a preset value μₛₑₜ.

A specific example is provided below to help understand a method for obtaining a sampling matrix ϕ_{N}, N=20 to be optimized in the manner of cycling according to a greedy sequential scheme in alternating directions:

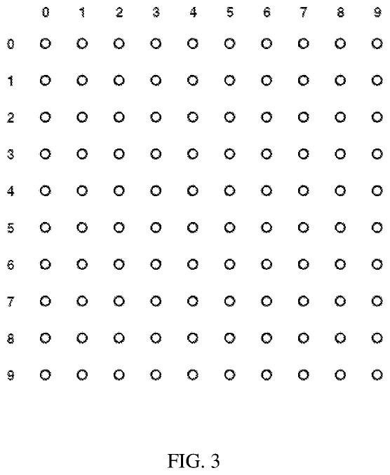

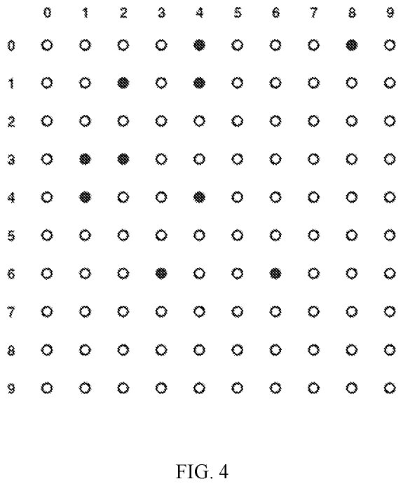

Assume that the sampled scene is a 10*10 spatial grid points shown in FIG. 3 (the open circles are spatial grid points). Assuming that 10 sample points ϕₖ have been determined, i.e. k=10 (positions such as solid dots in FIG. 4), the position of the next sample point needs to be determined.

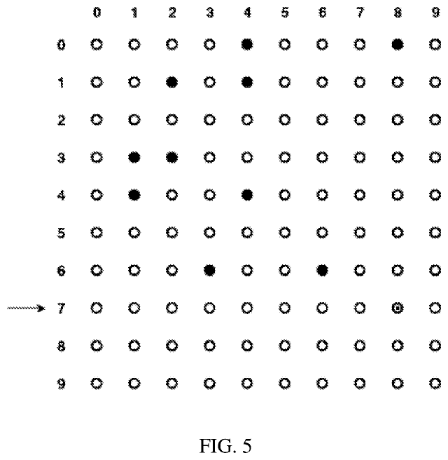

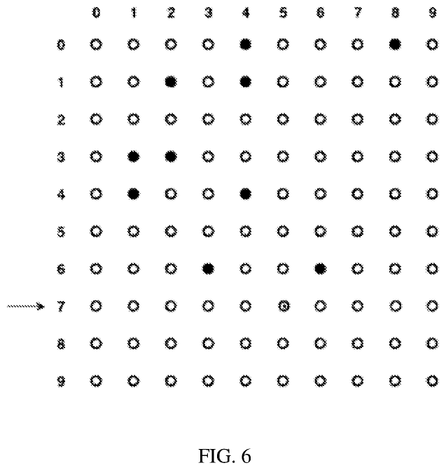

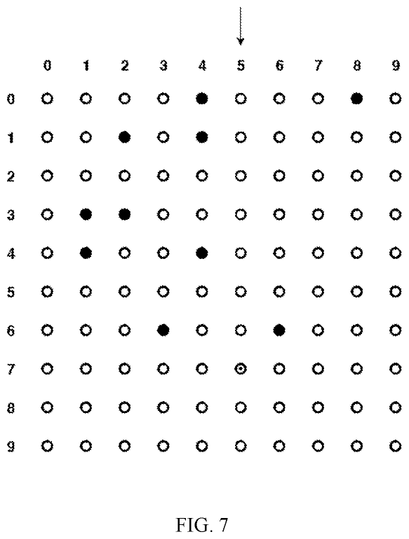

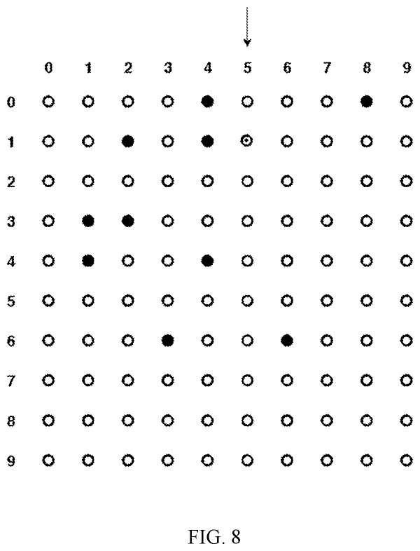

In the unsampled grid points, an unsampled point (7, 8) is randomly selected as a candidate point (a position such as an open circle having a circular point at the center in FIG. 5). Then, all the unsampled points are traversed along the x direction of the current candidate point as shown by an arrow in FIG. 5. Namely, all the unsampled grid points of a row with the abscissa of 7 are traversed, and the value μ of ϕₖ is respectively calculated after each unsampled point is added. The unsampled point causing the value μ to be minimum is selected to substitute the candidate point. Assuming that the unsampled point causing the value μ to be minimum is (7, 5), (7, 5) is taken as the updated candidate point, as shown in FIG. 6. Then, starting from the substituted candidate points (7, 5) as shown in FIG. 7, all the unsampled points are traversed in the y direction of (7, 5) shown by the arrow, that is, all the unsampled grid points in a column with the ordinate of 5 are traversed, the value μ of ϕₖ is calculated respectively after each unsampled point is added, and the unsampled point causing the value μ to be minimum is selected to substitute the candidate point. Assume that the unsampled point causing the value μ to be minimum is (1, 5), as shown in FIG. 8.

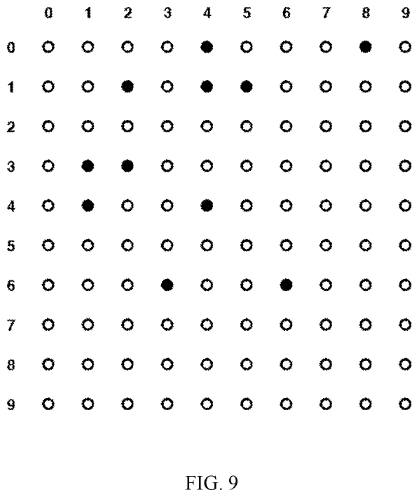

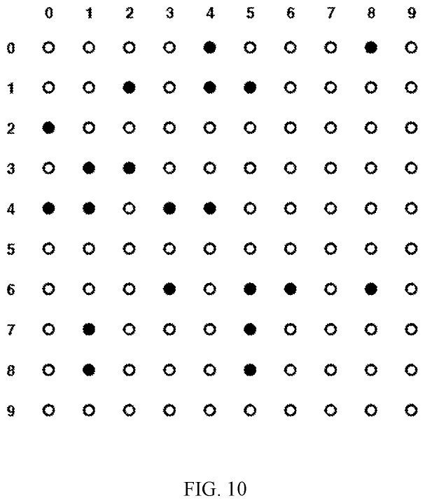

It is judged whether the substituted candidate point (1, 5) meets the requirement of causing the value μ to be minimum in the x direction and they direction; if not, the above traversal steps are repeated with (1, 5) as the candidate point until the substituted candidate point causes the value μ to be minimum in both the x direction and the y direction; and if so (YES in this example case), the substituted candidate point (1, 5) is added to the initial sampling matrix ϕₖ as shown in FIG. 9, and the initial sampling matrix is updated to ϕₖ₊₁. One sample point is added one after the other as described above until the sampling matrix ϕ_{N} containing 20 sample points is obtained as shown in FIG. 10, N=20.

In particular, a sampling matrix ϕ_{N} to be optimized is obtained in the manner of cycling by adopting a greedy sequential scheme in alternating directions, sampling points do not need to be mechanically and average densely arranged to a region, and suitable sampling points can be determined by the solution of the method even in a complex terrain region without performing candidate point optimization on the region which cannot be sampled. In addition, the solution has small calculation amount and high overall performance. The sampling number is less than that required by conventional regular sampling. It is not easy to fall into the local optimal solution of other irregular sampling solutions, and the sampling cost can be greatly reduced while the sampling effect is guaranteed.

After the sampling matrix ϕ_{N} to be optimized is determined, the step S101 in FIG. 1 continues to be executed as shown in FIG. 1, including sequentially reducing n sampling points for a sampling matrix ϕ_{N} to be optimized and updating the sampling matrix to ϕ_{N-n} according to a sampling reduction solution based on a greedy sequential scheme in alternating directions, where n is a preset fine-tuning amplitude value, and N is greater than n.

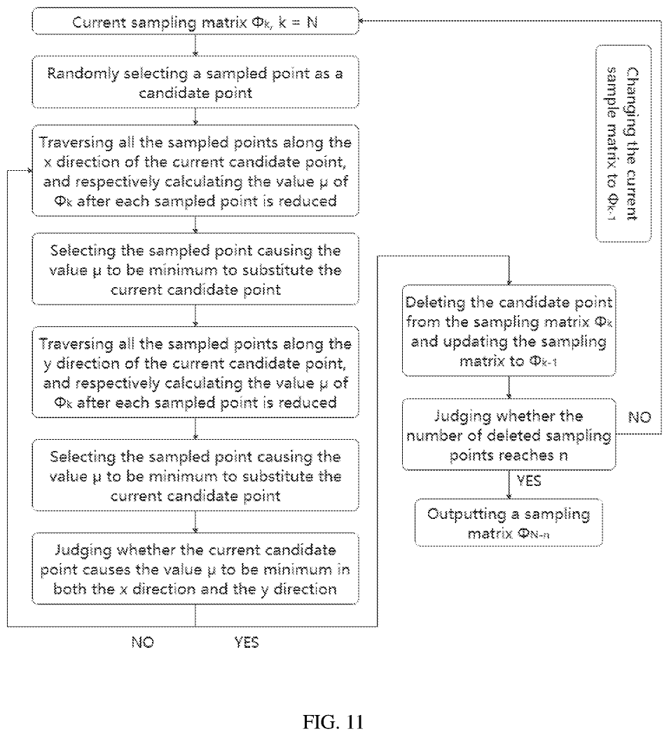

Specifically, the sampling reduction solution based on the greedy sequential scheme in alternating directions includes the following, as shown in FIG. 11:

Executing a traversal reduction cycle: randomly selecting one sampled point as a candidate point for the sampling matrix ϕ_{N} (i.e. in FIG. 11, P_{K}, K=N) to be optimized;

traversing all sampled points along the x direction of the candidate point, respectively calculating the value μ of ϕ_{N} after each sampled point is reduced, and selecting the sampled point causing the value μ to be minimum to substitute the candidate point; then traversing all the sampled points along the y direction of the substituted candidate point, respectively calculating the value μ of ϕ_{N} after each sampled point is reduced, and selecting the sampled point causing the value μ to be minimum to substitute the candidate point; next, judging whether the substituted candidate point causes the value pt to be minimum in the x direction and the y direction; if not, returning to repeatedly execute the traversal reduction cycle until the candidate point causes the value μ to be minimum in the x direction and the y direction; if so, deleting the candidate points from the sampling matrix ϕ_{N}, and updating the sampling matrix to ϕ_{N-1}; judging whether the number of deleted sampling points reaches a fine-tuning amplitude n; if not, repeating the traversal reduction cycle until the number of deleted sampling points reaches the fine-tuning amplitude; and if so, outputting the updated optimized sampling matrix ϕ_{N-n} at the current fine-tuning amplitude.

Then, step S102 in FIG. 1 is executed, including: sequentially adding n sampling points for ϕ_{N-n} and updating the sampling matrix to ϕ_{N} according to a sampling increment solution based on the greedy sequential scheme in alternate directions;

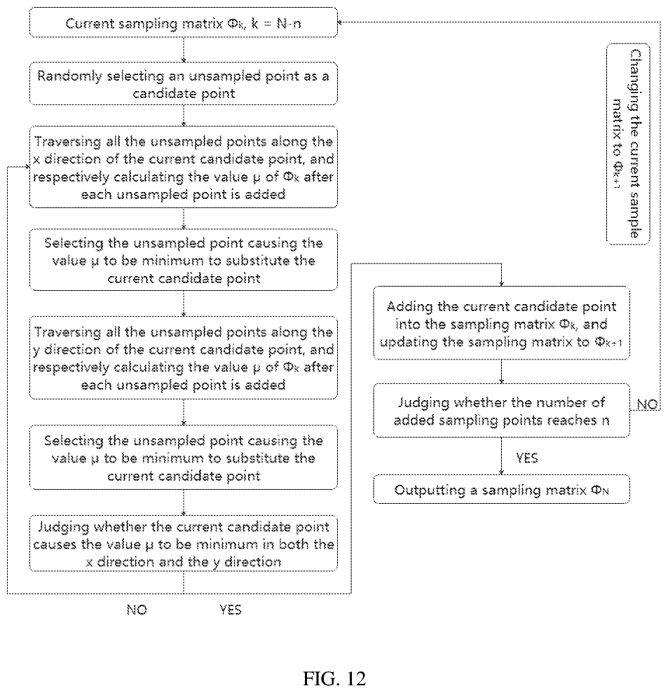

Specifically, the sampling increment solution based on the greedy sequential scheme in alternate directions includes the following, as shown in FIG. 12:

executing a traversal increase-cycle: randomly selecting one unsampled point as a candidate point for the sampling matrix ϕ_{N-n}. (i. e., in FIG. 12, ϕ_{K}, K=−n); traversing all the unsampled points along the x direction of the candidate point, respectively calculating the value μ of ϕ_{N-n} after each unsampled point is added, and selecting the unsampled point causing the value μ to be minimum to substitute the current candidate point; then traversing all the unsampled points along the y direction of the substituted candidate point, respectively calculating the value μ of ϕ_{N-n} after each unsampled point is added, and selecting the unsampled point causing the value μ to be minimum to substitute the candidate point; judging whether the substituted candidate point causes the value μ to be minimum in both the x direction and the y direction; if not, returning to repeat the traversal increment cycle until the candidate point causes the value μ to be minimum in the x direction and the y direction; and if so, adding the candidate point into the sampling matrix ϕ_{N-n}, and updating the sampling matrix to ϕ_{N-n+1}; then, judging whether the number of added sampling points reaches the fine-tuning amplitude n; if not, repeating the traversal increase cycle for ϕ_{N-n+1} until the number of added sampling points reaches the fine-tuning amplitude n; and if so, outputting the updated optimized sampling matrix ϕ_{N}′ at the current fine-tuning amplitude.

A specific example is provided below to help understand the sampling reduction solution and the sampling increment solution based on the greedy sequential scheme in alternating directions.

Assume that the sampling scene is 10*10 spatial grid points (the open circles are spatial grid points) as shown in FIG. 10, it has been determined that there are 20 sampling points (positions such as solid dots in FIG. 10) that require fine-tuning optimization.

First, the current sample points and the value μ are recorded. The fine-tuning amplitude n is determined, assuming n=2. n sampling points are removed one by one in a greedy sequential scheme, and n sampling points are added one by one. The method comprises the following steps.

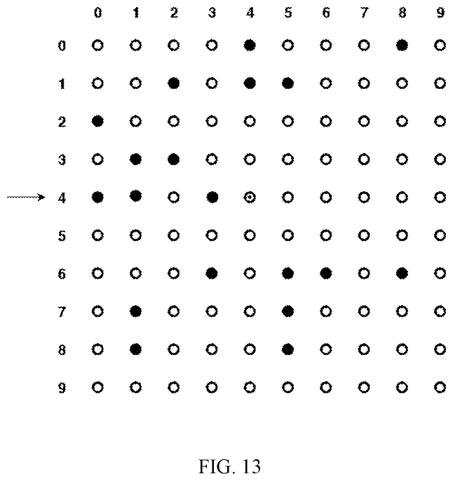

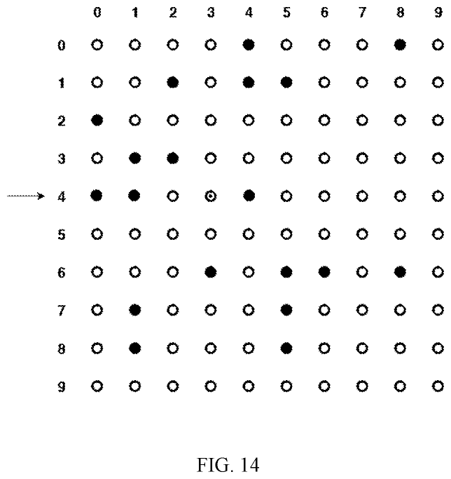

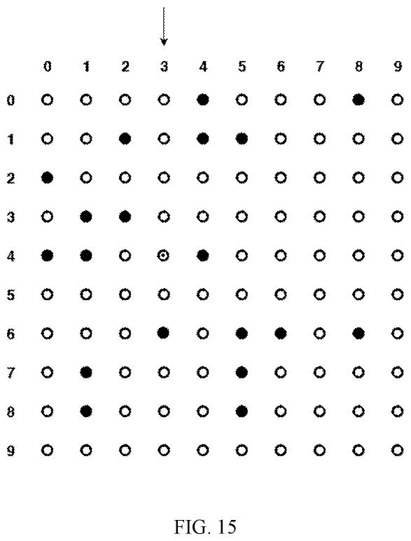

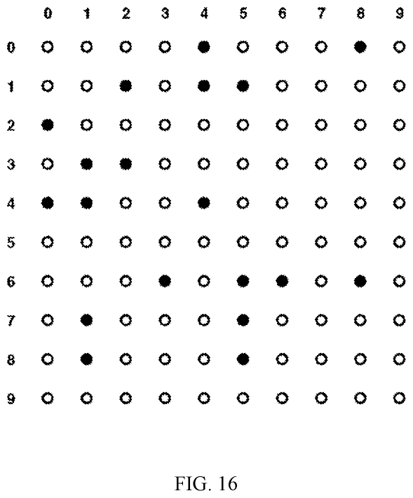

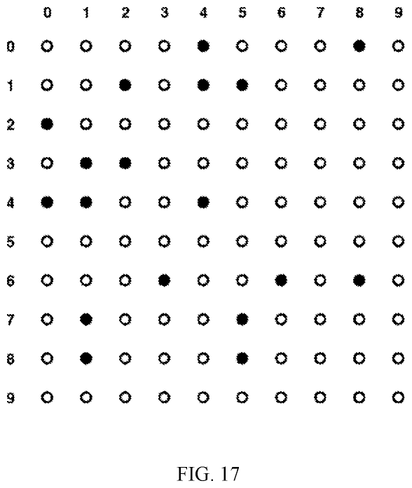

As shown in FIG. 13, a sample point is randomly selected as a candidate point (a position such as an open circle having a circular point at the center in FIG. 13), for example, (4, 4). All the sampled points are traversed in the x-direction of the candidate points as indicated by the arrow in FIG. 13, i.e. all the sampled points in a row with the abscissa 4 are traversed, and the de-sampled value μ of each point are calculated respectively. As shown in FIG. 14, the sampled point causing the value μ to be minimum is selected to substitute the candidate point, assuming that the sampled point causing the value μ to be minimum is (4, 3). Then, as shown in FIG. 15, all the sampled points are traversed in the y-direction of the substituted candidate points (4, 3), that is, all the sampled points in a column with the ordinate 3 are traversed, and the de-sampled value μ of each point is calculated respectively, and sampled point causing the value μ to be minimum is selected to substitute the candidate point, assuming that the sampled point causing the value μ to be minimum is still (4, 3). Next, whether the substituted candidate point causes the value μ to be minimum in the x direction and they direction is judged; if not, it returns to repeatedly execute the traversal reduction cycle until the candidate point causes the value μ to be minimum in the x direction and the y direction; and if so, the candidate point is deleted from the sampling matrix ϕ_{N}, and the sampling matrix is updated to ϕ_{N-1}. In the example case where (4, 3) minimizes the value μ in both the x direction and the y direction, the samples at (4, 3) are removed as shown in FIG. 16. The foregoing process is repeated, candidate points are obtained in alternating directions sequentially and de-sampled until the number of removed sample points reaches n. Since n=2, another sample point (6, 5) is assumed to be removed as shown in FIG. 17 to obtain ϕ_{N-n}.

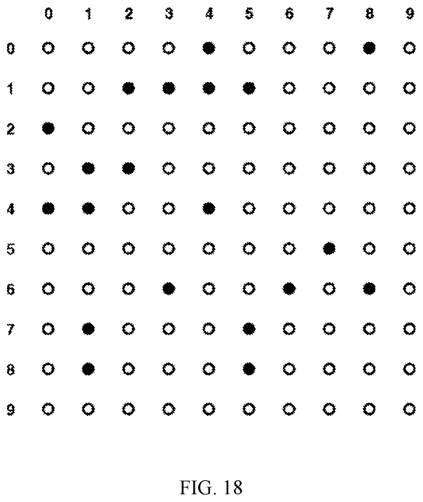

Then, on the basis of the de-sampled ϕ_{N-n}, n sampling points are sequentially added one by one in a greedy sequential scheme, and the method for specifically adding the sampling points is the same as the method for adding the sampling points when the sampling matrix ϕ_{N} to be optimized is obtained in the manner of cycling according to the greedy sequential scheme in alternating directions. For example, on the basis of ϕ_{N-n} shown in FIG. 17, an unsampled point (5, 3) is randomly selected as a candidate point, the new candidate point (5, 7) causing the value μ to be minimum is traversed in the x-direction (the row with the abscissa 5), and new candidate point causing the value μ to be minimum is traversed in the y-direction (row with ordinate 7). Assuming that the new candidate point found in the y-direction that minimizes the value ₁1 is still (5, 7), the new sample point (5, 7) is added. A new unsampled point (1, 1) is randomly selected as a candidate point. It traverses in the x direction (a row with the abscissa of 1) to obtain a new candidate point (1, 3) causing the value μ to be minimum, and traverses in the y direction (a row with the ordinate of 3) to obtain a new candidate point causing the value μ to be minimum. Assuming that the new candidate point found in the y-direction that minimizes the value μ is still (1, 3), the new sample point (1, 3) is added to obtain 20 optimized sample points as described in FIG. 18, i. e., the optimized sampling matrix ϕ_{N}′ at the current fine-tuning amplitude.

Then, the step S103 in FIG. 1 is executed, including judging whether the value μ of the current sampling matrix ϕ_{N} is less than the value μ of the sampling matrix ϕ_{N} according to the compressed sensing theory, and the value μ is a maximum cross-correlation value among column vectors of a sensing matrix in the compressed sensing theory.

If so, the step S104 is executed to change ϕ_{N} to ϕ_{N}, ending the fine-tuning cycle for ϕ_{N}, the fine-tuning cycle for ϕ_{N} is ended, and the fine-tuning cycle for ϕ_{N} is executed repetitively. If not, the step S105 is executed to reject the fine-tuning, and the rejection times of the current fine-tuning amplitude is added by one without changing the current sampling matrix.

And then, the step S106 is executed, including: judging whether the rejection times reaches a preset number m. Preferably, m varies inversely proportional to the fine-tuning amplitude n.

If not, the step S107 is executed, including: returning to repeatedly execute the fine-tuning cycle on the basis of the current sampling matrix until the rejection times reaches the preset number m. If so, the step S108 is executed, including: judging whether n meets a termination condition for overall optimization. The termination condition for overall optimization can be as follows: the fine-tuning amplitude n reaches a minimum nₛₑₜ of the preset fine-tuning amplitude (assumed to be 1 in FIG. 1).

If not, the step S109 is executed, including: reducing the fine-tuning amplitude n, and returning to repeatedly execute the fine-tuning cycle on the basis of the current sampling matrix until n meets the termination condition for overall optimization; if so, the step S110 is executed, including: ending the cycle and outputting a final optimized sampling matrix.

The theoretical basis of the method provided by the present application and the calculation method of the value μ are described as follows. The basic assumption of the compressed sensing theory is that the target signal has sparsity or compressibility, i.e. the target signal or its certain transform domain has only a limited number of components not equal to zero (corresponding to the sparsity), or only a limited number of components much greater than zero (corresponding to the compressibility). If the target signal has K components not equal to zero, the signal is said to be K sparse. Assuming that the target signal with sparsity or compressibility is x and the sparse transform adopts Fourier transform F, the orthogonal basis F is a Fourier basis function, and then x=F^{H}·s, where s is a sparse representation of the signal x in the Fourier domain; and F^{H} represents the conjugate transpose of F.

The acquired data may be viewed as the result of a multiplication of a sampling function or a sampling matrix with the target signal. The sampling matrix is denoted by ϕ. When a full sampling is performed, ϕ=I, and I denotes the unit matrix. When a sparse sampling is performed, is a matrix composed of a plurality of columns extracted from I, namely only column vectors corresponding to sampling positions are reserved, and the sampling data is y=ϕ·x=ϕ·-F^{H}·s=Ψ·s. In the formula, Ψ=ϕ·F^{H} is a sensing matrix.

According to the compressed sensing theory, a sufficient and necessary condition for the successful reconstruction of K sparse target signals is that the sensing matrix Ψ=ϕ·F^{H} ; satisfies the Restored Isometric Property (RIP) condition, i. e. (1−δ)∥v∥₂²≤∥Ψ·v∥₂²≤(1+δ)∥v∥₂² ≤(1+δ)∥v∥₂² is workable for any K sparse vector v (for each integer K=1, 2, . . . , the equidistant constant δ of the matrix Ψ is defined as δ_{K} at the minimum number K where the inequality is true). However, solving a matrix that satisfies the RIP condition is an NP-Hard problem, and instead a computable criterion can be used for a sampling design. Let the column vector of matrix be ϕᵢ, and the maximum cross-correlation value between the column vectors is

$$μ = \begin{matrix}max \\ i \neq j\end{matrix} \frac{\vert {Ψ}_{i}^{H} \cdot {Ψ}_{j} \vert}{\sqrt{\vert {Ψ}_{i}^{H} \cdot {Ψ}_{i} \vert} \cdot \sqrt{\vert {Ψ}_{j}^{H} \cdot {ψ}_{j} \vert}} .$$

The maximum cross-correlation value between the column vectors of the sensing matrix is a maximum non-zero frequency amplitude of an irregular sampling normalized spectrum. In the frequency domain, the spectrum of the sampled data y is the result of a convolution between the spectrum of the perceptual matrix Ψ and the spectrum of the sparse representation s of the target signal. μ is the maximum spectrum leakage caused by the fact that the orthogonality of the Fourier basis (sparse basis) is damaged due to irregular sampling, and the suppression to μ can enable the spectrum of the sensing matrix to approximate a Delta function. Otherwise, multiple peaks appear in the spectrum of the sensing matrix k-P, and after convolution action with a sparse expression s, false frequency noise is generated in a frequency domain (sparse domain).

The smaller the μ, the higher the probability that the signal can be reconstructed after irregular sampling. Since Ψ=ϕ·F^{H}, with F being fixed, when the number of samples is insufficient, the maximum cross correlation value can be reduced by changing the sampling matrix P, namely changing the distribution of irregular sampling points, so that the sampling matrix is optimized, and the probability of target signal reconstruction is improved, namely, \hat{ϕ}=arg min μ(ϕ). The optimization problem is non-convex, and it is sufficient to meet the demands by finding the local optimal solution for specific optimization.

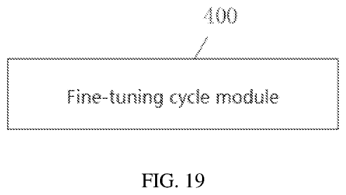

Based on the same inventive concept, the embodiments of the disclosure also provide an irregular optimized acquisition device for seismic data, as shown in FIG. 19, comprising:

a fine-tuning cycle module 400 configured for executing a following fine-tuning cycle:

sequentially reducing n sampling points for a sampling matrix ϕ_{N} to be optimized and updating the sampling matrix to ϕ_{N-n} according to a sampling reduction solution based on a greedy sequential scheme in alternating directions, n is a preset fine-tuning amplitude value, and N is greater than n;

sequentially adding n sampling points for ϕ_{N-n} and updating the sampling matrix to ϕ_{N}′ according to a sampling increment solution based on the greedy sequential scheme in alternate directions;

judging whether the value μ of the current sampling matrix ϕ_{N}′ is less than the value μ of the sampling matrix ϕ_{N} according to the compressed sensing theory, where the value μ is a maximum cross-correlation value among column vectors of a sensing matrix in the compressed sensing theory;

if so, changing ϕ_{N} to ϕ_{N}′, ending the fine-tuning cycle for ϕ_{N}, and repeatedly executing the fine-tuning cycle for ϕ_{N}′;

if not, increasing rejection times of the current fine-tuning amplitude by one without changing the current sampling matrix , and judging whether the rejection times reaches a preset number m; if not, returning to repeatedly execute the fine-tuning cycle on the basis of the current sampling matrix until the rejection times reaches the preset number m; if so, judging whether n meets a termination condition for overall optimization, and here, if not, reducing the fine-tuning amplitude n, and returning to repeatedly execute the fine-tuning cycle on the basis of the current sampling matrix until n meets the termination condition for overall optimization, and if so, ending the cycle and outputting a final optimized sampling matrix.

The acquisition device for seismic data may be a dedicated acquisition device or may be a computer or the like, without limitation here.

In the embodiments of the application, the device can further comprise a generation module of the sampling matrix to be optimized configured for:

letting an initial sampling matrix of the sampling matrix ϕ_{N} to be optimized be ϕₖ, where k is greater than 0 and less than N, an unsampled point is randomly selected as a candidate point, and a following first cycle is executed:

traversing all the unsampled points along the x direction of the current candidate point according to the compressed sensing theory, and respectively calculating the value μ of ϕₖ after each unsampled point is added; and selecting the unsampled point causing the value μ to be minimum to substitute the candidate point;

ending the first cycle, and executing a following second cycle by starting from the substituted candidate point:

traversing all the unsampled points along the y direction of the candidate point, and respectively calculating the value μ of ϕₖ after each unsampled point is added; and selecting the unsampled point causing the value μ to be minimum to substitute the candidate point;

judging whether the substituted candidate point meets that the value μ is minimum in both the x direction and they direction; if not, repeating the first cycle and the second cycle until the substituted candidate point causes the value μ to be minimum in the x direction and the y direction; if so, adding the substituted candidate point into the initial sampling matrix ϕₖ, updating the initial sampling matrix to ϕₖ₊₁, and judging whether a termination condition for a generation stage is met, and here, if not, repeating the cycle above, adding a new sampling point and updating the initial acquisition matrix until the termination condition of the generation stage is met, and if so, outputting the updated initial acquisition matrix as the acquisition matrix ϕ_{N} to be optimized.

Since the device described in the embodiments of the present disclosure is a device used for implementing the method of the embodiments of the present disclosure, based on the method described in the embodiments of the present disclosure, a person skilled in the art would be able to understand the specific structure and variations of the device, which will not be described in detail here. All devices used in the method of the embodiments of the disclosure are within the scope of the disclosure.

Based on the same inventive concept, the embodiments of the disclosure also provide an electronic apparatus, which comprises a memory 510, a processor 520 and a computer program 511, the computer program 511 is stored on the memory 510 and can run on the processor 520, and the following steps are realized when the computer program 511 is executed by the processor 520:

executing a following fine-tuning cycle:

sequentially reducing n sampling points for a sampling matrix ϕ_{N} to be optimized and updating the sampling matrix to ϕ_{N-n} according to a sampling reduction solution based on a greedy sequential scheme in alternating directions, n is a preset fine-tuning amplitude value, and N is greater than n;

sequentially adding n sampling points for ϕ_{N-n} and updating the sampling matrix to ϕ_{N}′ according to a sampling increment solution based on the greedy sequential scheme in alternate directions;

judging whether the value μ of the current sampling matrix ϕ_{N}′ is less than the value μ of the sampling matrix ϕ_{N} according to the compressed sensing theory, and the value μ is a maximum cross-correlation value among column vectors of a sensing matrix in the compressed sensing theory;

if so, changing ϕ_{N} to ϕ_{N}′, ending the fine-tuning cycle for ϕ_{N}, and repeatedly executing the fine-tuning cycle for ϕ_{N}′;

if not, increasing rejection times of the current fine-tuning amplitude by one without changing the current sampling matrix, and judging whether the rejection times reaches a preset number m; if not, returning to repeatedly execute the fine-tuning cycle on the basis of the current sampling matrix until the rejection times reaches the preset number m; if so, judging whether n meets a termination condition for overall optimization, and here, if not, reducing the fine-tuning amplitude n, and returning to repeatedly execute the fine-tuning cycle on the basis of the current sampling matrix until n meets the termination condition for overall optimization, and if so, ending the cycle and outputting a final optimized sampling matrix.

In embodiments of the present disclosure, any implementation of the methods of embodiments of the present disclosure may be implemented when the processor 520 executes the computer program 511.

Since the apparatus described in the embodiments of the present disclosure is an apparatus used for implementing the method of the embodiments of the present disclosure, based on the method described in the embodiments of the present disclosure, a person skilled in the art would be able to understand the specific structure and variations of the apparatus, which will not be described in detail here. All apparatuses used in the method of the embodiments of the disclosure fall within the scope of the disclosure.

Based on the same inventive concept, the embodiments of the disclosure also provide a storage medium corresponding to the method in the embodiments.

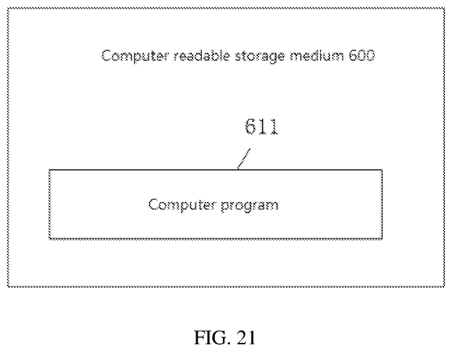

The present embodiments provide a computer readable storage medium 600, as shown in FIG. 21, having stored thereon a computer program 611 which, when executed by a processor, implements the following steps:

executing a following fine-tuning cycle:

sequentially reducing n sampling points for a sampling matrix ϕ_{N} to be optimized and updating the sampling matrix to ϕ_{N-n} according to a sampling reduction solution based on a greedy sequential scheme in alternating directions, n is a preset fine-tuning amplitude value, and N is greater than n;

sequentially adding n sampling points for ϕ_{N-n} and updating the sampling matrix to ϕ_{N}′ according to a sampling increment solution based on the greedy sequential scheme in alternate directions;

judging whether the value μ of the current sampling matrix ϕ_{N}′ is less than the value μ of the sampling matrix ϕ_{N} according to the compressed sensing theory, and the value μ is a maximum cross-correlation value among column vectors of a sensing matrix in the compressed sensing theory;

if so, changing ϕ_{N} to ϕ_{N}′, ending the fine-tuning cycle for ϕ_{N}, and repeatedly executing the fine-tuning cycle for ϕ_{N}′;

if not, increasing rejection times of the current fine-tuning amplitude by one without changing the current sampling matrix, and judging whether the rejection times reaches a preset number m; if not, returning to repeatedly execute the fine-tuning cycle on the basis of the current sampling matrix until the rejection times reaches the preset number m; if so, judging whether n meets a termination condition for overall optimization, and here, if not, reducing the fine-tuning amplitude n, and returning to repeatedly execute the fine-tuning cycle on the basis of the current sampling matrix until n meets the termination condition for overall optimization, and if so, ending the cycle and outputting a final optimized sampling matrix.

In particular implementations, any implementation of the methods of embodiments of the present disclosure may be implemented when the computer program 611 is executed by the processor.

The technical solution provided by the embodiments of the disclosure has at least the following technical effects or advantages.

According to the method, device, apparatus, and medium provided by the embodiments of the disclosure, the sampling matrix is updated from the sampling matrix ON to be optimized to ϕ_{N}′ by combining a sampling reduction solution based on a greedy sequential scheme in alternate directions and a sampling increment solution based on the greedy sequential scheme in alternate directions, and whether the value μ of the updated sampling matrix ϕ_{N}′ is less than that of the sampling matrix ϕ_{N} is judged according to the compressed sensing theory to judge whether the fine-tuning is accepted; and the trend of fine-tuning is to make the sampling matrix meet the requirements of better integrity and ensure the reliability of sampling results. Furthermore, whether the rejection times reaches a preset number m is taken as a cycle judgment condition, and the fine-tuning amplitude n is gradually reduced to execute the cycle to determine a final optimized sampling matrix. Therefore, the final optimized sampling matrix subjected to fine-tuning optimization does not need to perform mechanical average division and arrange average densely sampling points to a region, and suitable sampling points can be determined by the solution of the disclosure even in a complex terrain region without performing candidate point optimization on the region which cannot be sampled. In addition, the solution has small calculation amount and high overall performance, and can guarantee the reliability of a sampling result by updating the sampling points based on overall fine-tuning optimization. The sampling number is less than that required by conventional regular sampling. It is not easy to fall into the local optimal solution of other irregular sampling solutions, and the sampling cost can be greatly reduced while the sampling effect is guaranteed.

The algorithms and displays provided herein are not inherently related to any particular computer, virtual system, or other apparatus. Various general-purpose systems may also be used with the teachings herein. The structure required to construct such a system is apparent from the above description. In addition, the present disclosure is not directed to any particular programming language. It should be understood that the subject matter described herein may be implemented in a variety of programming languages and that the foregoing description of specific languages is intended to disclose the preferred implementation of the present disclosure.

In the description provided herein, numerous specific details are set forth. It will be understood, however, that embodiments of the disclosure may be practiced without these specific details. In some instances, well-known methods, structures, and techniques have not been shown in detail in order not to obscure an understanding of this description.

Similarly, it should be understood that in the foregoing description of exemplary embodiments of the disclosure, various features of the disclosure are sometimes grouped together in a single embodiment, figure, or description thereof in order to simplify the disclosure and facilitate an understanding of one or more of the various inventive aspects.

However, this disclosed method should not be construed to reflect the following intent, that is, the claimed disclosure requires more features than are expressly recited in each claim. Rather, as the following claims reflect, inventive aspects are less than all features of a single embodiment disclosed above. Thus, the claims following the detailed description are hereby expressly incorporated into this detailed description, with each claim itself as a separate embodiment of this disclosure.

Those skilled in the art will appreciate that the modules in the device in the embodiments may be adapted and arranged in one or more apparatuses different from the embodiments. The modules or units or components of the embodiments may be combined into one module or unit or component, and further divided into a plurality of sub-modules or sub-units or sub-components. All of the features disclosed in this specification (including accompanying claims, the abstract and drawings), and all of the processes or elements of any method or apparatus so disclosed, may be combined in any combination, except combinations where at least some of such features and/or processes or elements are mutually exclusive. Each feature disclosed in this specification (including accompanying claims, the abstract and drawings), may be substituted by alternative features serving the same, equivalent or similar purpose, unless expressly stated otherwise.

Moreover, those skilled in the art will appreciate that while some embodiments herein include some features included in other embodiments rather than other features, combinations of features of different embodiments are meant to be within the scope of the disclosure and to form different embodiments. For example, in the following claims, any of the claimed embodiments may be used in any combination.

Various component embodiments of the disclosure may be implemented in hardware, in software modules running on one or more processors, or in a combination thereof. Those skilled in the art will appreciate that a microprocessor or digital signal processor (DSP) may be used in practice to implement some or all of the functions of the gateway, proxy server, some or all of the components in the system according to embodiments of the present disclosure. The present disclosure may also be implemented as an apparatus or device program (e.g., a computer program and a computer program product) for performing some or all of the methods described herein. Such a program embodying the disclosure may be stored on a computer readable medium, or may take the form of one or more signals. Such signals may be downloaded from an Internet website, or provided on a carrier signal, or provided in any other form.

It should be noted that the above-mentioned embodiments illustrate rather than limit the disclosure, and that those skilled in the art will be able to design alternative embodiments without departing from the scope of the appended claims. In the claims, any reference signs placed between parentheses shall not be construed as limiting the claims. The word “comprising” does not exclude the presence of elements or steps not listed in a claim. The word “a” or “an” preceding a component does not exclude the presence of a plurality of such components. The disclosure may be implemented by means of hardware comprising several distinct components, and by means of a suitably programmed computer.

In the unit claims enumerating several means, several of these means can be embodied by one and the same item of hardware. The use of the words first, second, third, etc. does not indicate any order. These words can be interpreted as names.

What is claimed is:

1. An irregular optimization acquisition method for seismic data, comprising steps of:
executing a fine-tuning cycle, comprising:
sequentially reducing n sampling points for a sampling matrix ϕ_{N} to be optimized and updating the sampling matrix to ϕ_{N-n} according to a sampling reduction solution based on a greedy sequential scheme in alternating directions, wherein n is a preset fine-tuning amplitude value, and N is greater than n;
sequentially adding n sampling points for ϕ_{N-n} and updating the sampling matrix to ϕ_{N}′ according to a sampling increment solution based on the greedy sequential scheme in alternate directions;
judging whether a value μ of a current sampling matrix ϕ_{N}′ is less than the value μ of the sampling matrix ϕ_{N} according to a compressed sensing theory, wherein the value μ is a maximum cross-correlation value among column vectors of a sensing matrix in the compressed sensing theory;
if so, changing ϕ_{N} to ϕ_{N}′, ending the fine-tuning cycle for ϕ_{N} and repeatedly executing the fine-tuning cycle for ϕ_{N}′;
if not, increasing rejection times of a current fine-tuning amplitude by one without changing the current sampling matrix, and judging whether the rejection times reaches a preset number m; if not, returning to repeatedly execute the fine-tuning cycle on a basis of the current sampling matrix until the rejection times reaches the preset number m; if so, judging whether n meets a termination condition for overall optimization, and here, if not, reducing the fine-tuning amplitude n, and returning to repeatedly execute the fine-tuning cycle on the basis of the current sampling matrix until n meets the termination condition for overall optimization, and if so, ending the cycle and outputting a final optimized sampling matrix.

2. The irregular optimization acquisition method for seismic data according to claim 1, wherein the termination condition for overall optimization is that
the fine-tuning amplitude n reaches a minimum value nₛₑₜ of a preset fine-tuning amplitude.

3. The irregular optimization acquisition method for seismic data according to claim 1, wherein the sampling reduction solution based on a greedy sequential scheme in alternating directions includes:
executing a traversal reduction cycle:
randomly selecting one sampled point as a candidate point for a sampling matrix ϕ_{N}; traversing all sampled points along an x direction of the candidate point, respectively calculating the value μ of ϕ_{N} after each sampled point is reduced, and selecting the sampled point causing the value μ to be minimum to substitute the candidate point;
traversing all sampled points along a y direction of a substituted candidate point, respectively calculating the value μ of ϕ_{N} after each sampled point is reduced, and selecting the sampled point causing the value μ to be minimum to substitute the candidate point; judging whether the substituted candidate point causes the value μ to be minimum in both the x direction and the y direction; if not, returning to repeat the traversal reduction cycle until the candidate point causes the value μ to be minimum in the x direction and the y direction; and if so, deleting the candidate point from the sampling matrix ϕ_{N}, and updating the sampling matrix to ϕ_{N-1};
judging whether a number of deleted sampling points reaches a fine-tuning amplitude n; if not, repeating the traversal reduction cycle for ϕ_{N-1} until the number of deleted sampling points reaches the fine-tuning amplitude n; and if so, outputting an updated optimized sampling matrix ϕ_{N-n} at a current fine-tuning amplitude.

4. The irregular optimization acquisition method for seismic data according to claim 1, wherein the sampling increment solution based on the greedy sequential scheme in alternate directions includes:
executing a traversal increase cycle:
randomly selecting one unsampled point as a candidate point for the sampling matrix ϕ_{N-n}; traversing all unsampled points along the x direction of the candidate point, respectively calculating the value μ of ϕ_{N-n} after each unsampled point is added, and selecting an unsampled point causing the value μ to be minimum to substitute a current candidate point;
traversing all the unsampled points along the y direction of the substituted candidate point, respectively calculating the value μ of ϕ_{N-n} after each unsampled point is added, and selecting the unsampled point causing the value μ to be minimum to substitute the candidate point;
judging whether the substituted candidate point causes the value μ to be minimum in both the x direction and the y direction; if not, returning to repeat the traversal increase cycle until the candidate point causes the value μ to be minimum in the x direction and the y direction; and if so, adding the candidate point into the sampling matrix ϕ_{N-n}, and updating the sampling matrix to ϕ_{N-n+1};
judging whether a number of added sampling points reaches the fine-tuning amplitude n; if not, repeating the traversal increase cycle for ϕ_{N-n+1} until the number of added sampling points reaches the fine-tuning amplitude n; and if so, outputting the updated optimized sampling matrix ϕ_{N}′ at the current fine-tuning amplitude.

5. The irregular optimization acquisition method for seismic data according to claim 1, further comprising a generation solution of the sampling matrix to be optimized:
letting an initial sampling matrix of the sampling matrix ϕ_{N} to be optimized be ϕₖ, wherein k is greater than 0 and less than N, an unsampled point is randomly selected as a candidate point, and a following first cycle is executed:
traversing all the unsampled points along the x direction of the current candidate point according to compressed sensing theory, and respectively calculating the value μ of ϕₖ after each unsampled point is added; and selecting the unsampled point causing the value μ to be minimum to substitute the candidate point;
ending the first cycle, and executing a following second cycle by starting from the substituted candidate point:
traversing all the unsampled points along the y direction of the candidate point, and respectively calculating the value μ of ϕₖ after each unsampled point is added; and selecting the unsampled point causing the value μ to be minimum to substitute the candidate point;
judging whether the substituted candidate point meets that the value μ is minimum in both the x direction and the y direction; if not, repeating the first cycle and the second cycle until the substituted candidate point causes the value μ to be minimum in the x direction and the y direction; if so, adding the substituted candidate point into the initial sampling matrix ϕₖ, updating the initial sampling matrix to ϕₖ₊₁, and judging whether a termination condition for a generation stage is met, and here, if not, repeating the cycle above, adding a new sampling point and updating an initial acquisition matrix until the termination condition of the generation stage is met, and if so, outputting an updated initial acquisition matrix as the acquisition matrix ϕ_{N} to be optimized.

6. The irregular optimization acquisition method for seismic data according to claim 5, wherein the termination condition of the generation stage is that
a number k+1 of sampling points of an updated initial sampling matrix ϕₖ₊₁ reaches a preset sampling number N; or the value μ of the updated initial sampling matrix ϕₖ₊₁ is less than a preset value μₛₑₜ.

7. An irregular optimization acquisition device for seismic data, comprising a fine-tuning cycle module configured for:
executing a following fine-tuning cycle:
sequentially reducing n sampling points for a sampling matrix ϕ_{N} to be optimized and updating the sampling matrix to ϕ_{N-n} according to a sampling reduction solution based on a greedy sequential scheme in alternate directions, where n is a preset fine-tuning amplitude value, and N is greater than n;
sequentially adding n sampling points for ϕ_{N-n} and updating the sampling matrix to ϕ_{N}′ according to a sampling increment solution based on the greedy sequential scheme in alternate directions;
judging whether a value μ of the current sampling matrix ϕ_{N}′ is less than the value μ of the sampling matrix ϕ_{N} according to the compressed sensing theory, wherein the value μ is a maximum cross-correlation value among column vectors of a sensing matrix in the compressed sensing theory;
if so, changing ϕ_{N} to ϕ_{N}′, ending the fine-tuning cycle for ϕ_{N}, and repeatedly executing the fine-tuning cycle for ϕ_{N}′;
if not, increasing rejection times of the current fine-tuning amplitude by one without changing the current sampling matrix, and judging whether the rejection times reaches a preset number m; if not, returning to repeatedly execute the fine-tuning cycle on the basis of the current sampling matrix until the rejection times reaches the preset number m; if so, judging whether n meets a termination condition for overall optimization, and here, if not, reducing the fine-tuning amplitude n, and returning to repeatedly execute the fine-tuning cycle on the basis of the current sampling matrix until n meets the termination condition for overall optimization, and if so, ending the cycle and outputting a final optimized sampling matrix.

8. The irregular optimization acquisition device for seismic data according to claim 7, further comprising a generation module of the sampling matrix to be optimized configured for:
letting an initial sampling matrix of the sampling matrix ϕ_{N} to be optimized be ϕₖ, wherein k is greater than 0 and less than N, an unsampled point is randomly selected as a candidate point, and a following first cycle is executed:
traversing all the unsampled points along the x direction of the current candidate point according to the compressed sensing theory, and respectively calculating the value μ of ϕₖ after each unsampled point is added; and selecting the unsampled point causing the value n to be minimum to substitute the candidate point;
ending the first cycle, and executing a following second cycle by starting from the substituted candidate point:
traversing all the unsampled points along the y direction of the candidate point, and respectively calculating the value μ of ϕₖ after each unsampled point is added; and selecting the unsampled point causing the value μ to be minimum to substitute the candidate point;
judging whether the substituted candidate point meets that the value μ is minimum in both the x direction and the y direction; if not, repeating the first cycle and the second cycle until the substituted candidate point causes the value μ to be minimum in the x direction and the y direction; if so, adding the substituted candidate point into the initial sampling matrix ϕₖ, updating the initial sampling matrix to ϕₖ₊₁, and judging whether a termination condition for a generation stage is met, and here, if not, repeating the first cycle and the second cycle above, adding a new sampling point and updating the initial acquisition matrix until the termination condition of the generation stage is met, and if so, outputting the updated initial acquisition matrix as the acquisition matrix ϕ_{N} to be optimized.

9. An irregular optimization acquisition apparatus for seismic data, comprising a memory, a processor and a computer program stored on the memory and executable on the processor, wherein the processor, when executing the computer program, implements the steps of the method according to claim 1.

10. An irregular optimization acquisition medium for seismic data having stored thereon a computer program which, when executed by a processor, implements the steps of the method according to claim 1.
